(19) United States
(12) Patent Application Publication
(10) Pub. No.: US 2004/0091342 A1
(43) Pub. Date: May 13, 2004

(54) Semiconductor chip pickup device

(76) Inventors: Kouichi Yajima, Tokyo (JP); Kuniaki Tsurushima, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/471,406

(22) PCT Filed: Feb. 3, 2003
(86) PCT No.: PCT/JP03/01048

(30) Foreign Application Priority Data
Feb. 4, 2002 (JP) 2002-26269

(51) Int. Cl. B65G 65/04

(52) U.S. Cl. 414/416.01; 29/743

(57) ABSTRACT

A semiconductor chip pickup apparatus comprises support means for supporting a tape having many semiconductor chips adhered onto the face of the tape; and pickup means for individually picking up the semiconductor chips from the face of the tape supported on the support means. The support means includes a plurality of support lines, extending parallel at spaced locations, for supporting the back of the tape. Suction means is disposed for sucking the back of the tape, thereby peeling the tape from the semiconductor chips in regions other than the support lines.

### TECHNICAL FIELD

This invention relates to a semiconductor chip pickup apparatus for peeling and picking up many semiconductor chips, adhered to the face of a tape, individually from the face of the tape.

### BACKGROUND ART

For production of a semiconductor chip, as is well known, the face of a semiconductor wafer is divided into many rectangular regions by streets arranged in a lattice pattern, and a semiconductor circuit is formed in each of the rectangular regions. Then, if desired, the back of the semiconductor wafer is ground to decrease the thickness of the semiconductor wafer, whereafter the semiconductor wafer is diced, namely, cut along the streets to separate the rectangular regions individually. The separated individual rectangular regions constitute semiconductor chips. In recent times, a method utilizing so-called prior dicing has found practical use. According to this method, the semiconductor wafer is diced from its face to a predetermined depth, rather than throughout its thickness, along the streets to form grooves of the predetermined depth, and then the back of the semiconductor wafer is ground to make the thickness of the semiconductor wafer not more than the depth of the grooves, whereby the rectangular regions are separated individually. In either method, when the semiconductor wafer is to be separated into the individual rectangular regions, the back or face of the semiconductor wafer is adhered to a tape. When the rectangular regions have been separated individually, therefore, the individually separated rectangular regions, namely, semiconductor chips, are adhered onto the tape. Hence, subsequent to grinding and cutting of the semiconductor wafer, the many semiconductor chips adhered onto the tape need to be individually stripped from the tape and picked up.

A conventional semiconductor chip pickup device for individually picking up semiconductor chips from the face of a tape comprises support means for supporting a tape having many semiconductor chips adhered onto the face thereof; peeling means for inserting a plurality of small needles through the tape from its back to peel one semiconductor chip from the face of the tape and raise the semiconductor chip; and pickup means for vacuum-sucking the semiconductor chip, which has been peeled from the face of the tape and raised, to pick it up.

The conventional semiconductor chip pickup device, however, poses the problem that if the semiconductor chip is thin, for example, its thickness is 100 μm or less, contact of the needles, which have been inserted through the tape, with the semiconductor chip may frequently result in damage to the semiconductor chip.

### DISCLOSURE OF THE INVENTION

It is, therefore, a principal object of the present invention to provide a novel semiconductor chip pickup apparatus which can peel and pick up many semiconductor chips, adhered onto a tape, individually from the tape without damaging the semiconductor chips, even when the semiconductor chips are markedly thin.

We, the inventors of the present invention, conducted in-depth studies, and have found that the above principal object can be attained by using support means, of a form including a plurality of support lines extending parallel at spaced locations, for supporting the back of a tape, and by disposing suction means for sucking the back of the tape supported on the plurality of support lines, thereby peeling the tape from the semiconductor chips in regions other than the support lines.

That is, according to the present invention, there is provided, as a semiconductor chip pickup apparatus for attaining the above-mentioned principal object, a semiconductor chip pickup apparatus for individually peeling and picking up many semiconductor chips, adhered onto the face of a tape, from the tape, the semiconductor chip pickup apparatus comprising support means for supporting the tape having the many semiconductor chips adhered onto the surface thereof; and pickup means for individually picking up the semiconductor chips from the face of the tape supported on the support means, characterized in that

the support means includes a plurality of support lines, extending parallel at spaced locations, for supporting the back of the tape; and

suction means is disposed for sucking the back of the tape supported on the plurality of support lines of the support means, thereby peeling the tape from the semiconductor chips in regions other than the support lines.

Preferably, the support means includes a porous member, and a plurality of thin wires disposed above the porous member, the plurality of thin wires are spaced from each other and arranged parallel to each other to constitute the support lines, and the suction means sucks through the porous member. It is also preferred that the support means includes a support member having a flat plate portion and a plurality of ridges formed on the flat plate portion; the plurality of ridges are spaced from each other and arranged parallel to each other to constitute the support lines; a plurality of vent holes located between the ridges are disposed in the flat plate portion; and the suction means sucks through the vent holes. The individual semiconductor chip is preferably supported on at least two of the support lines via the tape. The width of contact between each of the support lines of the support means and the back of the tape is preferably 0.1 to 1.0 mm. The support lines of the support means can be disposed in a region substantially equal to, or somewhat larger than, the area of the region where all of the many semiconductor chips adhered onto the face of the tape are existent, so that all of the semiconductor chips adhered onto the face of the tape can be simultaneously supported by the support lines. Instead, the support lines of the support means can be disposed in a region substantially equal to, or somewhat larger than, the area of the region where one semiconductor chip adhered onto the face of the tape is existent, so that the support means is movable along the back of the tape.

### BRIEF DESCRIPTION OF THE DRAWINGS

FIG. 1 is a sectional view showing a preferred embodiment of a semiconductor chip pickup apparatus constructed in accordance with the present invention.

FIG. 2 is a perspective view showing support means in the semiconductor chip pickup apparatus.

FIG. 3 is a perspective view showing a state of many semiconductor chips adhered to the face of a tape stuck to a frame.

FIG. 4 is a sectional view showing, on an enlarged scale, a portion of the semiconductor chip pickup apparatus of FIG. 1.

FIG. 5 is a sectional view showing a modified embodiment of the support means.

FIG. 6 is a sectional view showing another modified embodiment of the support means.

### BEST MODE FOR CARRYING OUT THE INVENTION

Preferred embodiments of a semiconductor chip pickup apparatus constructed in accordance with the present invention will be described in greater detail by reference to the accompanying drawings.

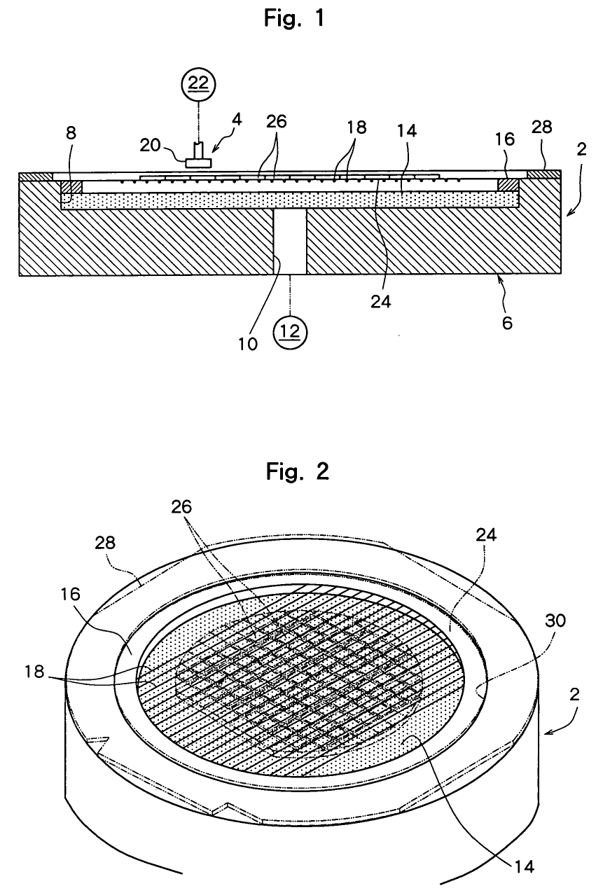

Referring to FIG. 1, the semiconductor chip pickup apparatus comprises support means 2 and pickup means 4. The illustrated support means 2 includes a nearly disk-shaped base plate 6. A circular recess 8 is formed in an upper surface of the base plate 6. In the base plate 6, a ventilation path 10 is also formed which extends from a lower surface of the base plate 6 to the circular recess 8. The ventilation path 10 is selectively brought into communication with a vacuum source 12 via a suitable communication path (not shown). As will be understood from descriptions to be offered later, the vacuum source 12 constitutes suction means for sucking the back of a tape. A porous member 14 of a circular shape is mounted in the circular recess 8 of the base plate 6. The porous member 14 can be formed from a suitable porous material such as a porous ceramic. A ring member 16 is also mounted detachably within the circular recess 8. The ring member 16, which can be formed from a suitable metal or synthetic resin, is superposed on a peripheral edge portion of the porous member 14. As will be clearly understood by reference to FIG. 2 along with FIG. 1, many thin wires 18 are stretched across the ring member 16. Each of the thin wires 18, which may be metallic thin wires or plastic thin wires, can be stretched across the ring member 16, for example, by bonding its opposite ends to the inner peripheral surface of the ring member 16, or by inserting its opposite end portions through radial through-holes (not shown) formed in the ring member 16 and engaging them with the ring member 16. The many thin wires 18 extend parallel at equally spaced locations. As will be clearly understood from later explanations, the many thin wires 18 constitute support lines for supporting a tape onto whose face many semiconductor chips have been adhered. If semiconductor chips to be supported on the thin wires 18 are changed to those of different dimensions, the ring member 16 can be replaced by one in which the spacing between the thin wires 18 corresponds to the changed dimensions of the semiconductor chips.

The pickup means 4 in the illustrated embodiment includes a suction head 20 which is movable in arbitrary directions. A porous suction plate (not shown) is disposed on the lower surface of the suction head 20 which may be of a well known form per se. Such a suction plate is selectively brought into communication with a vacuum source 22 via a suitable communication line (not shown).

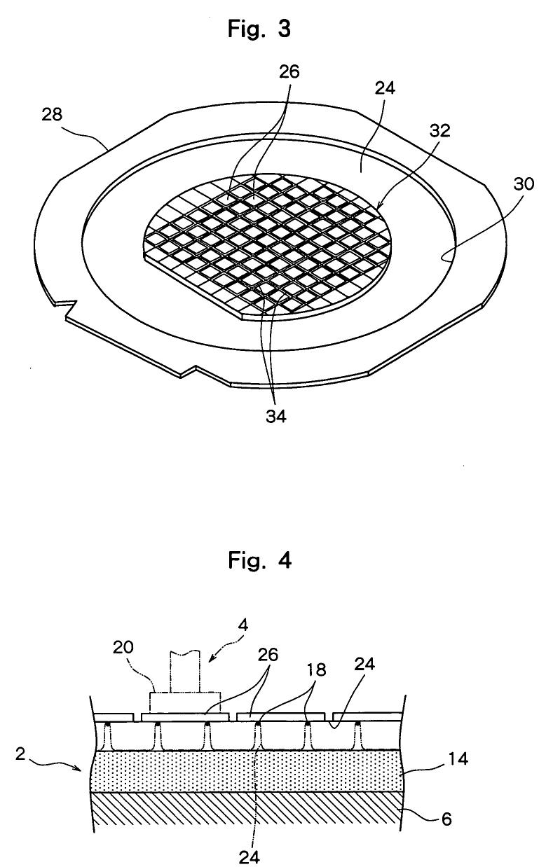

FIG. 3 shows a tape 24, and many semiconductor chips 26 adhered to the face of the tape 24. In the illustrated embodiment, the tape 24 itself is stuck to the lower surface of a frame 28 having a circular opening 30 at the center thereof, and the tape 24 extends in such a manner as to straddle the opening 30 of the frame 28. Within the circular opening 30 of the frame 28, the many semiconductor chips 26 are adhered to the face of the tape 24. The semiconductor chips 26 are formed by dividing a nearly disk-shaped semiconductor wafer 32 along streets 34 arranged in a lattice pattern. Thus, the semiconductor chips 26 are arranged in rows and columns on the face of the tape 24.

To separate and pick up the semiconductor chips 26 individually from the site on the face of the tape 24, the frame 28 having the tape 24 stuck thereto, as indicated by solid lines in FIGS. 1 and 4 and by two-dot chain lines in FIG. 2, is placed on a peripheral edge portion of the upper surface of the base plate 6 in the support means 2 (namely, in the edge portion around the circular recess 8). Desirably, the frame 28 is located on the base plate 6 such that the opposite side edges of each of the semiconductor chips 26 are substantially parallel to the thin wires 18. By so doing, the many semiconductor chips 26 adhered onto the face of the tape 24 are supported on the thin wires 18 of the support means 2 via the tape 24, as clearly shown in FIG. 4. In order that each of the semiconductor chips 26 is supported on the thin wires 18 fully stably, it is preferred that the individual semiconductor chip 26 be supported on altogether two or three or more of the thin wires 18 via the tape 24. Advantageously, the width of contact between each of the thin wires 18 and the back of the tape 24 is sufficiently small, for example, about 0.1 to 1.0 mm. Then, the ventilation path 10 of the base plate 6 is brought into communication with the vacuum source 12. As a result, the back of the tape 24 is sucked via the porous member 14 and, as shown exaggeratedly by two-dot chain lines in FIG. 4, the tape 24 is urged downwardly in regions other than the thin wires 18, and thereby peeled from each of the semiconductor chips 26. With such a state being maintained, the lower surface of the suction head 20 constituting the pickup means 4 is brought into intimate contact or into proximity to the upper surface of the individual semiconductor chip 26 to attract the semiconductor chip 26 to the suction head 20, thereby pick it up from the face of the tape 24 and transport it to a required site. When each of the semiconductor chips 26 is peeled from the face of the tape 24, a great force is not locally imposed on the semiconductor chip 26. There is no or a very low risk of damage to the semiconductor chip 26 whose thickness is considerably small.

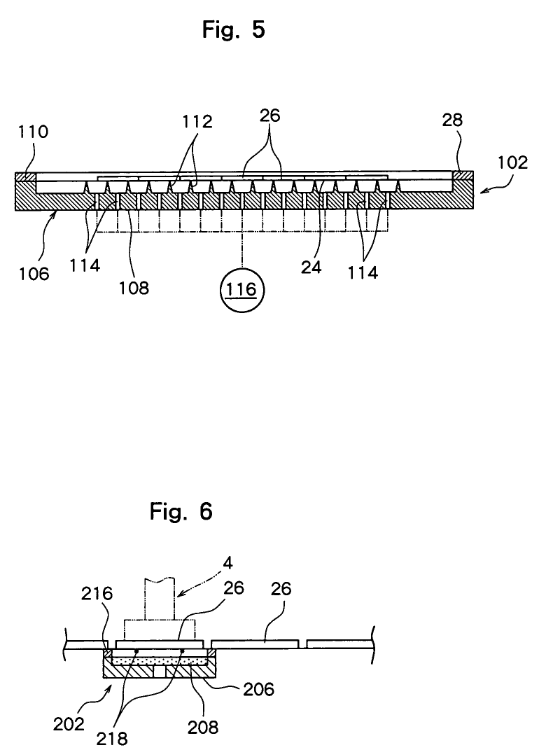

FIG. 5 shows a modified embodiment of the support means. Support means 102 illustrated in FIG. 5 is constituted of a support member 106 in the shape of a flat plate. The support member 106 has a flat plate portion 108, and an upwardly protruding annular peripheral wall 110 integrally formed at the peripheral edge of the flat plate portion 108. A plurality of ridges 112 are integrally formed on the upper surface of the flat plate portion 108. The ridges 112 extend parallel at equally spaced locations and perpendicularly to the sheet face of FIG. 5. The upper end of the ridge 112 and the upper surface of the annular peripheral wall 110 may be at substantially the same height. Between the respective ridges 112, a plurality of vent holes 114 are formed at spaced locations as vertical through-holes in the flat plate portion 108. These vent holes 114 extend perpendicularly to the sheet face of FIG. 5 (accordingly, in the direction of extension of the ridges 112). In this support means 102, the plural ridges 112 constitute support lines for supporting the semiconductor chips 26 via the tape 24 (FIG. 3 should also be referred to). That is, in individually peeling and picking up the semiconductor chips 26 from the face of the tape 24, the frame 28 is placed on the annular peripheral wall 110 of the support member 106 such that the many semiconductor chips 26 adhered onto the face of the tape 24 are supported on the ridges 112 via the tape 24, desirably with the opposite side edges of the respective semiconductor chips 26 being substantially parallel to the ridges 112. In this case as well, in order that each of the semiconductor chips 26 is supported on the ridges 112 fully stably, it is preferred that the individual semiconductor chip 26 be supported on altogether two or three or more of the ridges 112 via the tape 24. Advantageously, the width of contact between each of the ridges 112 and the back of the tape 24 is sufficiently small, for example, about 0.1 to 1.0 mm. Then, the vent holes 114 formed in the flat plate portion 108 of the support member 104 are brought into communication with suction means, i.e., a vacuum source 116 via a suitable communication path (not shown). As a result, the back of the tape 24 is sucked via the vent holes 114, whereby the tape 24 is urged downwardly in regions other than the ridges 112, and thereby peeled from each of the semiconductor chips 26. Each of the semiconductor chips 26 peeled from the face of the tape 24 can be picked up by suitable pickup means and conveyed to a required site, as in the case of the semiconductor chip pickup apparatus that has been described with reference to FIGS. 1 to 4.

In the support means 2 in the semiconductor chip pickup apparatus described with reference to FIGS. 1 to 4, and in the support means 102 illustrated in FIG. 5, the support lines for supporting the semiconductor chips 26 via the tape 24, namely, the fine wires 18 and the ridges 112, are disposed in a region substantially equal to or somewhat larger than the area of the region where all of the many semiconductor chips 26 adhered onto the tape 24 are existent (accordingly, the area of the semiconductor wafer before being separated into the individual semiconductor chips 26 along the streets 34). Thus, all of the semiconductor chips 26 adhered onto the tape 24 are simultaneously supported by the support lines (i.e. the thin wires 18 or the ridges 112). When the semiconductor chips 26 are to be individually picked up, the pickup means 4 is moved along the tape 24, while the support means 2 and 102 remain stationary. If desired, however, support lines in support means 202 can be disposed only in a region substantially equal to or somewhat larger than the area of the region where one semiconductor chip 26 adhered to the face of the tape 24 is existent, as schematically shown in FIG. 6. The support means 202 shown in FIG. 6 is such that a base plate 206, a porous member 214 and a ring member 216 corresponding to the base plate 6, porous member 14 and ring member 16 in the support means 2 shown in FIGS. 1 and 2 are downsized to dimensions suitable for one (to several) semiconductor chip 26, and that only two thin wires 208 enough to support one semiconductor chip 26 are stretched across the ring member 216. If such support means 202 is used, it is necessary to support the frame 28, to which the tape 24 has been adhered, by separately disposed suitable support means (not shown). To peel and pick up the individual semiconductor chips 26 from the face of the tape 24, there is need to move the support means 202 appropriately along the back of the tape 24, and sequentially locate the support means 202, as well as the pickup means 4, relative to the individual semiconductor chips 26.

1. A semiconductor chip pickup apparatus for individually peeling and picking up many semiconductor chips, adhered onto a face of a tape, from the tape, said semiconductor chip pickup apparatus comprising support means for supporting the tape having the many semiconductor chips adhered onto the face thereof; and pickup means for individually picking up the semiconductor chips from the face of the tape supported on said support means, characterized in that
said support means includes a plurality of support lines, extending parallel at spaced locations, for supporting a back of the tape, and
suction means is disposed for sucking the back of the tape supported on said plurality of support lines of said support means, thereby peeling the tape from the semiconductor chips in regions other than said support lines.

2. The semiconductor chip pickup apparatus according to claim 1, wherein said support means includes a porous member, and a plurality of thin wires disposed above said porous member, said plurality of thin wires are spaced from each other and arranged parallel to each other to constitute said support lines, and said suction means sucks through said porous member.

3. The semiconductor chip pickup apparatus according to claim 1, wherein said support means includes a support member having a flat plate portion and a plurality of ridges formed on said flat plate portion; said plurality of ridges are spaced from each other and arranged parallel to each other to constitute said support lines; a plurality of vent holes located between said ridges are disposed in said flat plate portion; and said suction means sucks through said vent holes.

4. The semiconductor chip pickup apparatus according to claim 1, wherein the individual semiconductor chip is supported on at least two of said support lines via the tape.

5. The semiconductor chip pickup apparatus according to claim 1, wherein a width of contact between each of said support lines of said support means and the back of the tape is 0.1 to 1.0 mm.

6. The semiconductor chip pickup apparatus according to claim 1, wherein said support lines of said support means are disposed in a region substantially equal to, or somewhat larger than, an area of a region where all of the many semiconductor chips adhered onto the face of the tape are existent, so that all of the semiconductor chips adhered onto the face of the tape are simultaneously supported by said support lines.

7. The semiconductor chip pickup apparatus according to claim 1, wherein said support lines of said support means are disposed in a region substantially equal to, or somewhat larger than, an area of a region where one semiconductor chip adhered onto the face of the tape is existent, and said support means is movable along the back of the tape.
